(19) United States
(12) Patent Application Publication
(10) Pub. No.: US 2026/0011989 A1
(43) Pub. Date: Jan. 8, 2026

(54) CONFLUENCE FIXTURE

(71) Applicant: Fulian Precision Electronics (Tianjin) Co., LTD., Tianjin (CN)

(72) Inventors: WEI-MING LEE, New Taipei (TW); CHI-WEN CHEN, New Taipei (TW)

(21) Appl. No.: 18/901,699

(22) Filed: Sep. 30, 2024

(30) Foreign Application Priority Data
Jul. 5, 2024 (CN) 202410902099.8

(51) Int. Cl. H02G 3/04

(52) U.S. Cl. CPC H02G 3/0437

(57) ABSTRACT

A confluence fixture is provided used for converging and integrating wires, including a substrate, two side plates, a first conductive member, a second conductive member, and at least one third conductive member. The substrate includes an input side and an output side. The two side plates are connected to the substrate and enclose a first space with the substrate. The first conductive member, the second conductive member, and the third conductive member are arranged in the first space at intervals, and the first conductive member, the second conductive member, and the third conductive member are each provided with a plurality of first connectors on the input side and a plurality of second connectors on the output side, and the first connectors are electrically connected to the second connectors.

### CROSS-REFERENCE TO RELATED APPLICATIONS

This application claims priority to Chinese Patent Application No. 202410902099.8 filed on Jul. 5, 2024, in China National Intellectual Property Administration, the contents of which are incorporated by reference herein.

### FIELD

The subject matter herein generally relates to wiring for electrical equipment field, and more particularly to a confluence fixture.

### BACKGROUND

Power supplies are widely used in all aspects of life. For example, some high-power power supplies are commonly used to power computer rooms or laboratories. Among these high-power power supplies, some output high-power power by connecting a plurality of low-power power supplies to a power-consuming equipment at the same time. In this case, the number of low-power power supplies connected to the power-consuming equipment can be flexibly adjusted according to the actual needs of use to obtain the required high-power power.

However, when the number of low-power power sources is large, wires connected to the power-consuming equipment will be very complicated, and the space at the wiring positions of the power-consuming equipment is limited. It is difficult to lock a large number of wires at the wiring positions of the power-consuming equipment at the same time, and the dense wires at the wiring positions are not conducive to sorting.

### BRIEF DESCRIPTION OF THE DRAWINGS

Implementations of the present disclosure will now be described, by way of embodiments, with reference to the attached figures.

FIG. 1 is a structural schematic diagram of a confluence fixture provided in one embodiment of the present application.

FIG. 2 is a schematic diagram showing the principle of integrating wires using the confluence fixture provided in one embodiment of the present application.

FIG. 3 is a schematic diagram showing a connection between third connectors of a second conductive member and third conductive members and connection terminals provided in one embodiment of the present application.

FIG. 4 is a structural diagram of the confluence fixture including a shutter provided in one embodiment of the present application.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

When a plurality of low-power power supplies are used to supply power for power-consuming equipment, a same pole wire of the plurality of low-power power supplies often need to be connected to a same wiring terminal of the power-consuming equipment at the same time, resulting in very dense wiring at the wiring terminal, which is not convenient for locking and organizing. In addition, in some cases, due to the limitation of the size of the wiring terminal structure itself, it is impossible to connect to the wires of the plurality of power supplies at the same time, or the space at the location of the wiring terminal is limited, for example, the space is small, which makes it impossible to accommodate the wires of the plurality of power supplies to be connected at the same time.

Based on this, this application provides a confluence fixture used for converging and integrating wires. The confluence fixture includes a substrate, two side plates, a first conductive member, a second conductive member, and at least one third conductive member. The substrate includes an input side and an output side. The two side plates are connected to the substrate and enclose a first space with the substrate. The first conductive member, the second conductive member, and the at least one third conductive member are arranged in the first space at intervals, and the first conductive member, the second conductive member, and the at least one third conductive member are each provided with a plurality of first connectors on the input side and a plurality of second connectors on the output side, and the first connectors are electrically connected to the second connectors.

When the plurality of power supplies need to be connected to the power-consuming equipment, ground wires, neutral wires and live wires of the plurality of power supplies can be respectively connected to the plurality of first connectors of the first conductive member, the second conductive member, and the at least one third conductive member, and then the second connectors of the first conductive member, the second conductive member, and the at least one third conductive member are respectively connected to the ground wires, the neutral wires, and the live wires of the power-consuming equipment. In this way, by connecting the plurality of power supplies to the confluence fixture first and then connecting the confluence fixture to the power-consuming equipment, the number of ground wires, neutral wires, and live wires connected to the power-consuming equipment can be reduced, thereby reducing the density of wires at the wiring position of the power-consuming equipment, which is conducive to locking and organization. In addition, when the number of power supplies is large, a group of confluence fixtures can first perform a first-level confluence of the plurality of power supplies, and then other confluence fixtures can perform a second-level confluence of this group of confluence fixtures (similarly, there can be multiple levels of confluence), and the confluence fixture of the last level of confluence is connected to the ground wires, the neutral wires, and the live wires of the power-consuming equipment, which helps to reduce the load of a single confluence fixture.

Some embodiments of the present application will be described below in conjunction with the accompanying drawings. In the absence of conflict, the following embodiments and features in the embodiments may be combined with each other.

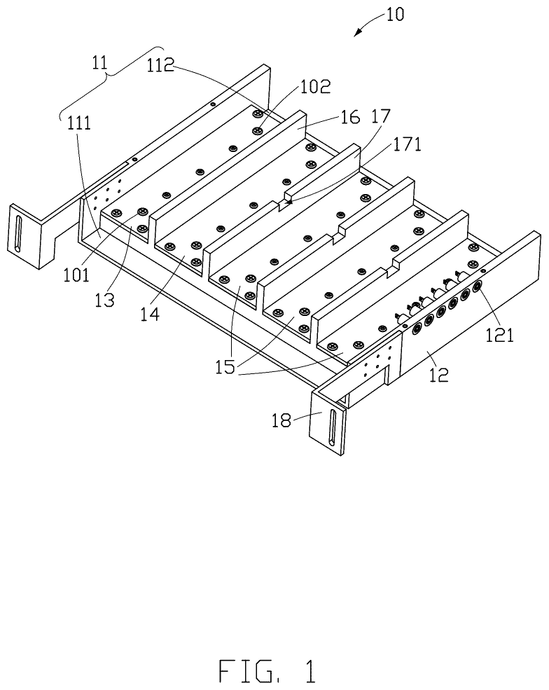

Referring to FIG. 1, FIG. 1 illustrates a structural schematic diagram of a confluence fixture 10 provided by one embodiment of the present application. The confluence fixture 10 is used for converging and integrating wires.

The confluence fixture 10 includes a substrate 11, two side plates 12, a first conductive member 13, a second conductive member 14, and at least one third conductive member 15. The substrate 11 includes an input side 111 and an output side 112. The two side plates 12 are connected to the substrate 11 and enclose a first space with the substrate 11. The first conductive member 13, the second conductive member 14, and the third conductive member 15 are arranged in the first space at intervals.

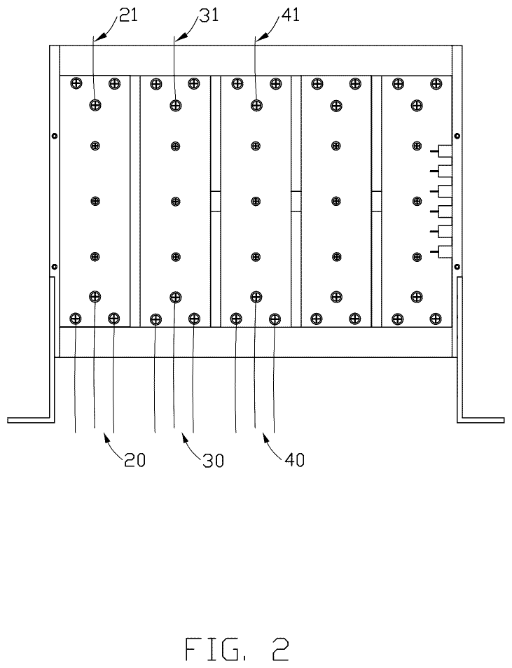

Referring to FIGS. 1 and 2, the first conductive member 13, the second conductive member 14, and the third conductive member 15 are each provided with a plurality of first connectors 101 on the input side 111 and a plurality of second connectors 102 on the output side 112, and the first connectors 101 are electrically connected to the second connectors 102.

When the confluence fixture 10 is connected to a single-phase power supply, the first connectors 101 of the first conductive member 13 are connected to ground wires 20 of the single-phase power supply, and the second connectors 102 of the first conductive member 13 are grounded. The first connectors 101 of the second conductive member 14 are connected to neutral wires 30 of the single-phase power supply, and the second connectors 102 of the second conductive member 14 are connected to neutral wires 31 of the power-consuming equipment. The first connectors 101 of the third conductive member 15 are connected to live wires 40 of the single-phase power supply, and the second connectors 102 of the third conductive member 15 are connected to live wires 41 of the power-consuming equipment.

Thus, when a plurality of single-phase power supplies need to be connected to power-consuming equipment, ground wires 20, neutral wires 30, and live wires 40 of the plurality of single-phase power supplies can be respectively connected to the plurality of first connectors 101 of the first conductive member 13, the second conductive member 14 and the third conductive member 15, and then the second connectors 102 of the first conductive member 13, the second conductive member 14 and the third conductive member 15 are respectively connected to the ground wires 21, the neutral wires 31 and the live wires 41 of the power-consuming equipment. By connecting the plurality of power supplies to the confluence fixture 10 first, and then connecting the confluence fixture 10 to the ground wires 21, the neutral wires 31 and the live wires 41 of the power-consuming equipment, the number of the ground wires 21, the neutral wire 31 and the live wire 41 connected to the power-consuming equipment can be reduced, thereby reducing the density of wires at the wiring position of the electrical device, which is beneficial for locking and organizing.

In some embodiments, a number of the third conductive member 15 can be three, which is beneficial for being connected to three-phase power supplies.

In some embodiments, when the number of power supplies exceeds the number of connections of the confluence fixture 10, for example, exceeds the number of first connectors 101, a plurality of confluence fixtures 10 can be used to connect to the power supplies to achieve a first-level confluence of the plurality of power supplies, and then other confluence fixtures 10 perform a second-level confluence of this group of confluence fixtures 10 (similarly, there can be a plurality of levels of confluence), and the confluence fixture 10 of a last level of confluence is connected to the ground wires 21, the neutral wires 31 and the live wires 41 of the power-consuming equipment, which helps to reduce the load of a single confluence fixture 10.

In some embodiments, the wire includes wiring terminals, and the wiring terminals are electrically connected to the first conductive member 13, the second conductive member 14 or the third conductive member 15 through the first connectors 101 and the second connectors 102.

In some embodiments, the wiring terminal can be an O-type terminal, and the first connectors 101 and the second connectors 102 can be screws.

In some embodiments, referring to FIGS. 1 to 3, the second conductive member 14 and the third conductive member 15 each include third connectors 103, the third connectors 103 are located between the first connectors 101 and the second connectors 102, and the third connectors 103 are electrically connected to the first connectors 101. At least two connection terminals 121 are provided on the side plate 12, and each connection terminal 121 can be electrically connected to the third connectors 103 of the second conductive member 14 and the third conductive member 15, respectively. In this way, when each connection terminal 121 is electrically connected to the third connectors 103 of the second conductive member 14 and the third conductive member 15 respectively, the connection terminal 121 is connected to an oscilloscope through an isolation probe, and the oscilloscope can measure and display voltage signals of the power supply after confluence by the confluence fixture 10.

In some embodiments, one of the first connectors 101, the second connectors 102, and the third connectors 103 can be used as connectors for the power input of the power-consuming equipment, and the others can be used as connectors for the power supply input to the confluence fixture 10. However, it is not limited to this, and can be set according to actual use needs.

In some embodiments, the third connectors 103 of the second conductive member 14 and the third conductive member 15 are connected to the connection terminals 121 through the wires having the wiring terminals.

In some embodiments, the third connectors 103 can be screws.

In some embodiments, the connection terminals 121 can be banana jacks.

In some embodiments, a minimum distance between the centers of two adjacent connection terminals 121 is about 20 millimeters. This is helpful to reduce mutual interference between the two adjacent connection terminals 121, thereby improving the accuracy of measurement.

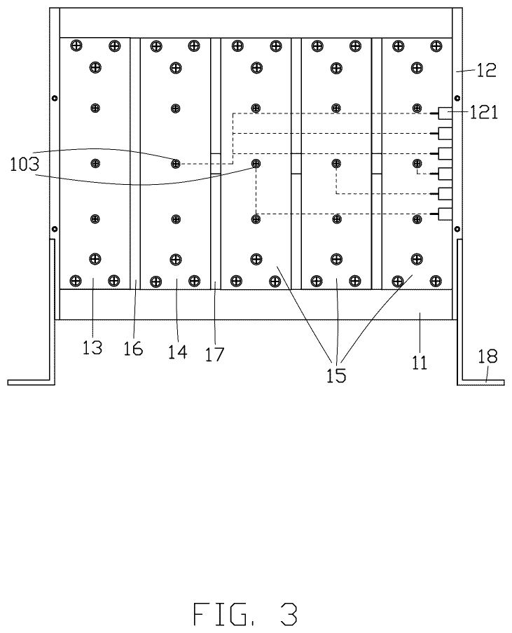

Referring to FIG. 3, the dotted line in FIG. 3 shows that when the number of the third conductive members 15 is three, the second conductive member 14 and the third connectors 103 of the third conductive members 15 are connected to different connection terminals 121. In FIG. 3, the third connector 103 of the second conductive member 14 is connected to three connection terminals 121, and the third connector 103 of each of the three third conductive members 15 are respectively connected to one connection terminal 121. In this way, the isolation probe can measure the voltage signal of each phase in the three-phase power supply by only connecting to the connection terminals 121, thereby improving the convenience of measurement.

In some embodiments, the third connector 103 of the second conductive member 14 is connected to only one connection terminal 121. When measuring the voltage signal of each phase in the three-phase power supply, each phase in the three-phase power supply is measured in turn. This helps to reduce the number of connection terminals 121 required for measurement.

Referring to FIG. 3, the second conductive member 14 and the third conductive member 15 are closer to the connection terminals 121 than the first conductive member 13. Thus, when measuring the voltage signal of the power supply, the third connectors 103 connected to the connection terminals 121 do not need to pass through the position of the first conductive member 13, which can reduce the interference of the first conductive member 13 on the measurement, thereby facilitating the improvement of the measurement accuracy.

Referring to FIGS. 1 to 3, the confluence fixture 10 further includes a first separator 16 and a second separator 17 connected to the substrate 11. The first separator 16 is arranged between the first conductive member 13 and the second conductive member 14, the second separator 17 is arranged between the second conductive member 14 and the third conductive member 15. In this way, the stability of the first conductive member 13, the second conductive member 14 and the third conductive member 15 being arranged in the first space can be improved, thereby facilitating the reduction of the mutual influence between adjacent conductive members. It can be understood that when the number of the third conductive members 15 is three, two adjacent third conductive members 15 are also separated by the second separator 17.

Referring to FIGS. 1 to 3, the second separator 17 defines a notch 171. The notch 171 is disposed on a side of the second separator 17 away from the substrate 11. The wires connected to the third connectors 103 can pass through the notch 171 and be connected to the connection terminals 121.

Referring to FIGS. 1 to 4, the confluence fixture 10 further includes mounting portions 18 connected to the two side plates 12. Each portion 18 defines an opening 181 exposed from the side plate 12. In this way, the wires connected to the first connector 101 or the second connector 102 can be led out from the side of the confluence fixture 10 through the opening 181, which helps to reduce the density of the wires between the two side plates 12.

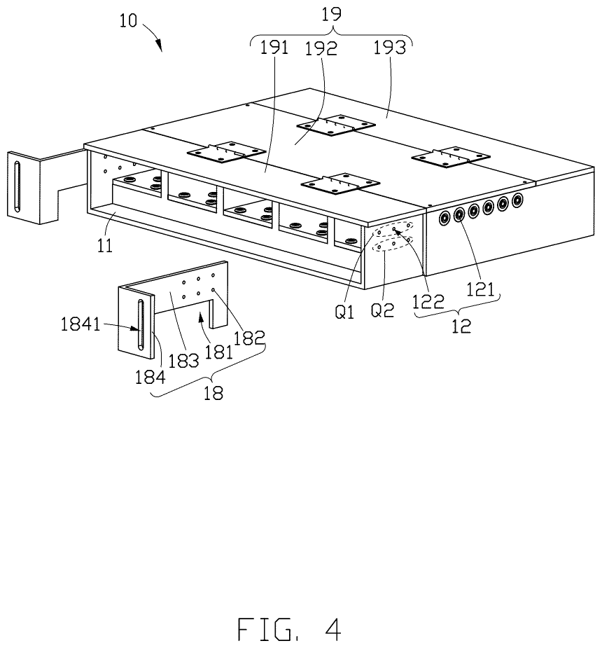

FIG. 4 illustrates that the mounting portion 18 is connected to a side of the side plate 12 close to the input side 111. It is understandable that the mounting portion 18 may also be connected to a side of the side plate 12 close to the output side 112.

In some embodiments, the power supply refers to a cabinet power supply, and both the cabinet power supply and the confluence fixture 10 can be mounted in the cabinet.

In some embodiments, the mounting portions 18 are used to be secured to the cabinet. In this way, when the confluence fixture 10 is mounted in the cabinet, the wires led out through the openings 181 can be hidden in gaps between the cabinet and the sides of the confluence fixture 10, so that the wires are easier to organize.

In some embodiments, the mounting portions 18 are movably connected to the side plates 12, so that the size of the opening 181 can be adjusted as needed according to the number of wires connected to the first connector 101 or the second connector 102.

In order to keep the adjusted opening 181 at the adjusted size, a method for movably connecting the mounting portions 18 and the side plates 12 is provided below.

Referring to FIG. 4, each side plate 12 includes a first region Q1, and a plurality of through holes 122 are provided in the first region Q1, and a wiring direction of the plurality of through holes 122 in the first region Q1 is parallel to the substrate 11. Each mounting portion 18 defines fixing holes 182, fastener(s) (not shown) passes through the fixing holes 182 and the through holes 122 to fix the mounting portion 18 to the side plate 12. In this way, by passing the fastener(s) through the fixing holes 182 and different through holes 122 in the first region Q1, the position of the mounting portion 18 can be adjusted.

Referring to FIG. 4, each side plate 12 further includes a second region Q2, and a plurality of through holes 122 are provided in the second region Q2, and a wiring direction of the plurality of through holes 122 in the second region Q2 is parallel to the substrate 11. The number of fasteners is at least two, and the at least two fasteners can pass through the fixing holes 182 and the through holes 122 in the first region Q1 and the second region Q2 to fix the mounting portion 18 to the side plate 12. In this way, at least two support points can be provided for the connection between the mounting portion 18 and the side panel 12. When the confluence fixture 10 converges more wires, even if the opening 181 is adjusted to the maximum position, the at least two support points can reduce a possibility of unexpected deflection of the mounting portion 18 and the side panel 12.

In some embodiments, the first region Q1 and the second region Q2 are respectively provided with three through holes 122. The number of through holes 122 respectively provided in the first region Q1 and the second region Q2 can also be two, four, five or more, or a combination thereof.

The outlines of the first region Q1 and the second region Q2 shown by the dotted lines in FIG. 4 are only for better indicating the approximate positions of the first region Q1 and the second region Q2, and do not limit the outlines of the first region Q1 and the second region Q2.

Referring to FIG. 4, each mounting portion 18 includes a first fixing block 183 and a second fixing block 184. The first fixing block 183 is connected to the side plate 12, and the second fixing block 184 is connected to the first fixing block 183. The first fixing block 183 is substantially parallel to the side plate 12, and the second fixing block 184 is substantially perpendicular to the side plate 12. In this way, the first fixing block 183 and the second fixing block 184 are connected to form a substantially “L” shape. When the confluence fixture 10 is mounted in the cabinet, the second fixing block 184 is used to facilitate the confluence fixture 10 to be locked relative to the cabinet.

Referring to FIG. 4, the second fixing block 184 defines a slot 1841 having a long strip-shape. Thus, when the mounting portion 18 is fixed to the cabinet via the second fixing block 184, the slot 1841 is helpful to adjust the relative position of the current confluence fixture 10 and the cabinet.

In some embodiments, a length direction of the slot 1841 is substantially perpendicular to the substrate 11.

In some embodiments, the opening 181 is disposed on the first fixing block 183. The fixing holes 182 are disposed on the first fixing block 183.

Referring to FIG. 4, the confluence fixture 10 further includes a shutter 19. The shutter 19 is disposed on the side plates 12 to shield the first space and the first conductive member 13, the second conductive member 14 and the third conductive member 15 disposed in the first space. This helps to reduce the occurrence of accidental touches, thereby improving the safety when using the confluence fixture 10.

Referring to FIG. 4, the shutter 19 includes a first portion 191, a second portion 192 and a third portion 193 connected in sequence along a direction from the input side 111 to the output side 112. The second portion 192 is fixed to the side plates 12, and the first portion 191 and the third portion 193 are rotatably connected to the second portion 192 respectively. In this way, by rotating the first portion 191 and the third portion 193 relative to the second portion 192, it is helpful to improve the convenience of connecting the first connector 101 or the second connector 102 to the wires.

Here, taking the example of integrating three low-power power supplies into one high-power power supply connected to the power-consuming equipment through the confluence fixture 10, the working process of the confluence fixture 10 is explained: first, the first portion 191 and the third portion 193 of the shutter 19 are rotated relative to the second portion 192 to expose the first connectors 101 and the second connectors 102 corresponding to each conductive member, and the ground wires 20, the neutral wires 30 and the live wires 40 of the three low-power power supplies are respectively connected to the first connectors 101 corresponding to each conductive member; secondly, adjusting the position of the mounting portions 18 relative to the side plates 12 so that the ground wires 20, the neutral wires 30 and the live wires 40 of the three low-power power supplies can be led out from the side of the confluence fixture 10 through the opening 181; finally, the second connectors 102 corresponding to the respective conductive members are respectively connected to the ground wires 21, the neutral wires 31 and the live wires 41 of the power-consuming equipment, and are input to the power-consuming equipment as the high-power power supply, and the first portion 191 and the third portion 193 of the shutter 19 are reset. Thus, the three low-power power supplies are integrated into one high-power power supply through the confluence fixture 10 and connected to the power-consuming equipment.

In some embodiments, the second portion 192 is fixed to the side plate 12 by screwing. In some embodiments, the second portion 192 is fixed to the side plate 12 by bonding. In some embodiments, the second portion 192 is fixed to the side plate 12 by snapping.

In some embodiments, the first portion 191 and the third portion 193 are rotatably connected to the second portion 192 through hinges.

In some embodiments, the shutter 19 is transparent, which is helpful to observe the connection between each connector and the wire.

In some embodiments, the material of the shutter 19 is plastic. For example, the material of the shutter 19 is PC plastic (polycarbonate).

In some embodiments, the material of the first conductive member 13, the second conductive member 14 and the third conductive member 15 includes copper. It is understood that the material of the first conductive member 13, the second conductive member 14 and the third conductive member 15 may include other materials that can be used for conducting electricity.

In some embodiments, the first conductive member 13, the second conductive member 14 and the third conductive member 15 have different colors, which is helpful for identifying each conductive element, thereby reducing the occurrence of misconnection.

In some embodiments, the substrate 11, the side plates 12 and the separators 16, 17 are made of insulating materials. For example, the substrate 11, the side panels 12 and the separators 16, 17 are made of bakelite. This helps to improve the insulation of the confluence fixture 10.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A confluence fixture configured for converging and integrating wires, the confluence fixture comprising:
a substrate comprising an input side and an output side;
two side plates connected to the substrate and enclosing a first space with the substrate; and
a first conductive member, a second conductive member, and at least one third conductive member arranged in the first space at intervals, wherein the first conductive member, the second conductive member, and the at least one third conductive member is each provided with first connectors on the input side and second connectors on the output side, and the first connectors are electrically connected to the second connectors.

2. The confluence fixture of claim 1, wherein the second conductive member and the at least one third conductive member each is further provided with third connectors, the third connectors are located between the first connectors and the second connectors, and the third connectors are electrically connected to the first connectors.

3. The confluence fixture of claim 2, wherein one of the two side plates is provided with at least two connection terminals, each of the at least two connection terminals is electrically connectable to the third connectors of the second conductive member and the at least one third conductive member, respectively.

4. The confluence fixture of claim 1, further comprising mounting portions connected to the two side plates, wherein each of the mounting portions defines an opening exposed from the side plate.

5. The confluence fixture of claim 4, wherein the mounting portions are movably connected to the two side plates.

6. The confluence fixture of claim 5, wherein each of the two side plates comprises a first region, the first region is provided with a plurality of through holes, a wiring direction of the plurality of through holes in the first region is parallel to the substrate, each of the mounting portions defines fixing holes, the plurality of through holes and the fixing holes are configured for fasteners to penetrate through to fix the mounting portion to the side plate.

7. The confluence fixture of claim 6, wherein each of the two side plates comprises a second region, a plurality of through holes are defined in the second region, a wiring direction of the plurality of through holes in the second region is parallel to the substrate, the fixing holes and the plurality of through holes in the first region and the second region are configured to accommodate at least two fasteners to penetrate through to fix the mounting portion to the side plate.

8. The confluence fixture of claim 6, wherein each of the mounting portion comprises a first fixing block and a second fixing block, the first fixing block is connected to the side plate, the second fixing block is connected to the first fixing block, the first fixing block is parallel to the side plate, and the second fixing block is perpendicular to the side plate.

9. The confluence fixture of claim 8, wherein the second fixing block defines a slot having a long strip-shape.

10. The confluence fixture of claim 8, wherein the opening is disposed on the first fixing block, the fixing holes are disposed on the first fixing block.

11. The confluence fixture of claim 1, further comprising a shutter disposed on the two side plates to shield the first space and the first conductive member, the second conductive member and the at least one third conductive member which are disposed in the first space.

12. The confluence fixture of claim 11, wherein the shutter comprises a first portion, a second portion and a third portion connected in sequence along a direction from the input side to the output side, the second portion is fixed to the two side plates, the first portion and the third portion are rotatably connected to the second portion respectively.

13. The confluence fixture of claim 3, further comprising a first separator and a second separator, wherein the first separator and the second separator are connected to the substrate, the first separator is arranged between the first conductive member and the second conductive member, the second separator is arranged between the second conductive member and the at least one third conductive member.

14. The confluence fixture of claim 13, wherein the confluence fixture comprises three third conductive members, every two adjacent third conductive members of the three third conductive members are further separated by the second separator.

15. The confluence fixture of claim 13, wherein the second separator defines a notch, the notch is disposed on a side of the second separator away from the substrate, the notch is configured to receive wires connected between the third connectors and the at least two connection terminals.
